(19) United States
(12) Patent Application Publication
(10) Pub. No.: US 2012/0077405 A1
(43) Pub. Date: Mar. 29, 2012

(54) Core/Shell Nanofiber Non-Woven

(76) Inventors: Hao Zhou, Spartanburg, SC (US); Walter A. Scrivens, Moore, SC (US)

(21) Appl. No.: 12/893,046

(22) Filed: Sep. 29, 2010

(51) Int. Cl. B32B 5/02; D01D 5/34; D04H 13/00

(52) U.S. Cl. 442/346; 442/364; 442/347; 264/172.15

(57) ABSTRACT

A core/shell nanofiber non-woven containing a plurality of core/shell nanofibers where at least 70% of the nanofibers are bonded to other nanofibers. The core of the nanofiber contains a core polymer and the shell of the nanofiber contains a shell polymer. At least a portion of the core polymer interpenetrates the shell of the nanofiber and at least a portion of the shell polymer interpenetrates the core of the nanofiber. The process for forming a core/shell nanofiber non-woven is also disclosed.

### RELATED APPLICATIONS

This application is related to the following applications, each of which is incorporated by reference: Attorney docket number 6275 entitled “Process of Forming Nano-Composite and Nano-Porous Non-Wovens”, attorney docket number 6483 entitled “Gradient Nanofiber Non-Woven”, attorney docket number 6406 entitled “Nanofiber Non-Wovens Containing Particles”, attorney docket number 6476 entitled “Process of Forming a Nanofiber Non-woven Containing Particles”, attorney docket number 6407 entitled “Multi-Layer Nano-Composites”, and attorney docket number 6477 entitled “Nanofiber Non-Woven Composite”, each of which being filed on Sep. 29, 2010.

### TECHNICAL FIELD

The present application is directed core/shell nanofiber non-wovens and the methods of making them.

### BACKGROUND

Nanofibers have a high surface area to volume ratio which alters the mechanical, thermal, and catalytic properties of materials. Nanofiber added to composites may either expand or add novel performance attributes to existing applications such as reduction in weight, breathability, moisture wicking, increased absorbency, increased reaction rate, etc. The market applications for nanofibers are rapidly growing and promise to be diverse. Applications include filtration, barrier fabrics, insulation, absorbable pads and wipes, personal care, biomedical and pharmaceutical applications, whiteners (such as TiO₂ substitution) or enhanced web opacity, nucleators, reinforcing agents, acoustic substrates, apparel, energy storage, etc. Due to their limited mechanical properties that preclude the use of conventional web handing, loosely interlaced nanofibers are often applied to a supporting substrate such as a non-woven or fabric material. The bonding of the nanofiber cross over points may be able to increase the mechanical strength of the nanofiber non-wovens which potentially help with their mechanical handling and offer superior physical performance. The high surface area offered by nanofibers is a great platform for adding functional chemistries to form core/shell structured nanofibers which may expand or enhance the favorable properties of the nanofibers.

### BRIEF SUMMARY

The present disclosure provides a core/shell nanofiber non-woven containing a plurality of core/shell nanofibers where at least 70% of the nanofibers are bonded to other nanofibers. The core of the nanofiber contains a core polymer and the shell of the nanofiber contains a shell polymer. At least a portion of the core polymer interpenetrates the shell of the nanofiber and at least a portion of the shell polymer interpenetrates the core of the nanofiber. The process for forming a core/shell nanofiber non-woven is also provided.

### BRIEF DESCRIPTION OF THE DRAWINGS

FIG. 1 illustrates a cross-section of one embodiment of a core/shell nanofiber non-woven.

FIG. 2 illustrates the cross-section of FIG. 1 magnified to show the core and shell of the nanofibers and the bonding of the nanofibers.

FIG. 3 illustrates a cross-section of one embodiment of a core/shell nanofiber non-woven having a matrix.

### DETAILED DESCRIPTION

“Nanofiber”, in this application, is defined to be a fiber having a diameter less than 1 micron. In certain instances, the diameter of the nanofiber is less than about 900, 800, 700, 600, 500, 400, 300, 200 or 100 nm, preferably from about 10 nm to about 200 nm. In certain instances, the nanofibers have a diameter from less than 100 nm. The nanofibers may have cross-sections with various regular and irregular shapes including, but not limiting to circular, oval, square, rectangular, triangular, diamond, trapezoidal and polygonal. The number of sides of the polygonal cross-section may vary from 3 to about 16.

“Non-woven” means that the layer or article does not have its fibers arranged in a predetermined fashion such as one set of fibers going over and under fibers of another set in an ordered arrangement.

As used herein, the term “thermoplastic” includes a material that is plastic or deformable, melts to a liquid when heated and freezes to a brittle, glassy state when cooled sufficiently. Thermoplastics are typically high molecular weight polymers. Examples of thermoplastic polymers that may be used include polyacetals, polyacrylics, polycarbonates, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polymethylpentene (and co-polymers thereof), polynorbornene (and co-polymers thereof), polyethylene terephthalates, polyvinylidene fluorides, polysiloxanes, or the like, or a combination comprising at least one of the foregoing thermoplastic polymers. In some embodiments, polyolefins include polyethylene, poly(α-olefin)s. As used herein, poly(α-olefin) means a polymer made by polymerizing an alpha-olefin. An α-olefin is an alkene where the carbon-carbon double bond starts at the α-carbon atom. Exemplary poly(α-olefin)s include polypropylene, poly(I-butene) and polystyrene. Exemplary polyesters include condensation polymers of a C₂₋₁₂ dicarboxylic acid and a C₂₋₁₂ alkylenediol. Exemplary polyamides include condensation polymers of a C₂₋₁₂ dicarboxylic acid and a C₂₋₁₂ alkylenediamine, as well as polycaprolactam (Nylon 6).

The high surface area offered by nanofibers is a great platform for adding functional chemistries to form core/shell structured nanofibers which will either expand or enhance the favorable properties of the nanofibers such as the wetting behavior, catalytic behavior, release kinetics, and conductivity etc. These properties are potentially beneficial for applications like the storage and drug delivery of bioactive agents, catalyst support, tissue engineering, microelectronic and filtration etc.

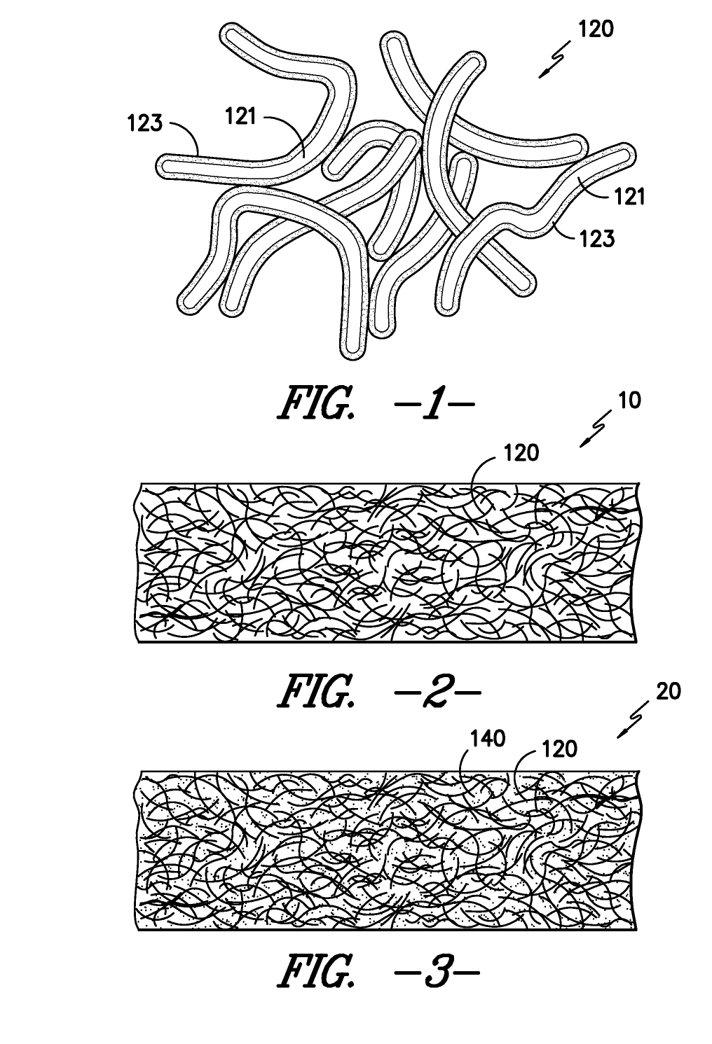

Referring to FIG. 2, there is shown a core/shell nanofiber non-woven 10 containing a plurality of core/shell nanofibers 120 where at least 70% of the nanofibers are bonded to other nanofibers. FIG. 1 shows an enlargement of the core/shell nanofiber non-woven 10 of FIG. 2 illustrating the core 121 and shell 123 of each of the core/shell nanofibers 120 and how the nanofibers are bonded to one another. While cores and shells are shown in FIG. 1 as having a one ratio of the thickness of the core to the shell, the thickness may vary based on polymers used and desired end product. Additionally, the fibers are shown touching and bonding for clarity, but may actually melt together where it would be difficult to determine where each of the individual fibers started and ended. The core of the nanofiber extends the length of the nanofiber and forms the center of the nanofiber. The shell of the fiber at least partially surrounds the core of the nanofiber, more preferably surrounds approximately the entire outer surface of the core. Preferably, the shell covers both the length of the core as well as the smaller ends of the core.

At least a portion of the core polymer interpenetrates the shell of the nanofiber and at least a portion of the shell polymer interpenetrates the core of the nanofiber. This occurs as the core and shell polymers are heated and formed together. The polymer chains from the core polymers interpenetrate the shell and the polymer chains from the shell polymer interpenetrate the core and the core and shell polymers intermingle. This would not typically occur from a simple coating of already formed nanofibers with a coating polymer.

The thermoplastic polymer forming the core 121 of the nanofibers 123 is referred herein as the core thermoplastic polymer. The thermoplastic polymer forming the shell 123 of the nanofibers 123 is referred to herein as the shell thermoplastic polymer.

In one embodiment shown in FIG. 3, the core/shell nanofiber non-woven 10 may also contain a thermoplastic polymer forming the matrix 140, which is referred herein as the matrix polymer. The core polymer, shell polymer, and matrix polymer may be formed of any suitable thermoplastic polymer that is melt-processable. The matrix polymer preferably is able to be removed by a condition to which the core and shell polymers are not susceptible to. The most common case is the matrix polymer is soluble in a first solvent in which the core and shell polymers are insoluble in. “Soluble” is defined as the state in which the intermolecular interactions between polymer chain segments and solvent molecules are energetically favorable and cause polymer coils to expand. “Insoluble” is defined as the state in which the polymer-polymer self-interactions are preferred and the polymer coils contract. Solubility is affected by temperature.

The first solvent may be an organic solvent, water, an aqueous solution or a mixture thereof. Preferably, the solvent is an organic solvent. Examples of solvents include, but are not limited to, acetone, alcohol, chlorinated solvents, tetrahydrofuran, toluene, aromatics, dimethylsulfoxide, amides and mixtures thereof. Exemplary alcohol solvents include, but are not limited to, methanol, ethanol, isopropanol and the like. Exemplary chlorinated solvents include, but are not limited to, methylene chloride, chloroform, tetrachloroethylene, carbontetrachloride, dichloroethane and the like. Exemplary amide solvents include, but are not limited to, dimethylformamide, dimethylacetamide, N-methylpyrollidinone and the like. Exemplary aromatic solvents include, but are not limited to, benxene, toluene, xylene (isomers and mixtures thereof), chlorobenzene and the like. In another embodiment, the matrix polymer may be removed by another process such as decomposition. For example, polyethylene terephthalate (PET) may be removed with base (such as NaOH) via hydrolysis or transformed into an oligomer by reacting with ethylene glycol or other glycols via glycolysis, or nylon may be removed by treatment with acid. In yet another embodiment, the second polymer may be removed via depolymerization and subsequent evaporation/sublimation of smaller molecular weight materials. For example, polymethyleneoxide, after deprotection, can thermally depolymerize into formaldehyde which subsequently evaporates/sublimes away.

The core, shell, and matrix polymers are thermodynamically immiscible with each other. Common miscibility predictors for non-polar polymers are differences in solubility parameters or Flory-Huggins interaction parameters. For polymers with non-specific interactions, such as polyolefins, the Flory-Huggins interaction parameter may be calculated by multiplying the square of the solubility parameter difference by the factor (V/RT), where V is the molar volume of the amorphous phase of the repeated unit V=M/Δ (molecular weight/density), R is the gas constant, and T is the absolute temperature. As a result, the Flory-Huggins interaction parameter between two non-polar polymers is always a positive number. Thermodynamic considerations require that for complete miscibility of two polymers in the melt, the Flory-Huggins interaction parameter has to be very small (e.g., less than 0.002 to produce a miscible blend starting from 100,000 weight-average molecular weight components at room temperature). It is difficult to find polymer blends with sufficiently low interaction parameters to meet the thermodynamic condition of miscibility over the entire range of compositions. However, industrial experience suggests that some blends with sufficiently low Flory-Huggins interaction parameters, although still not miscible based on thermodynamic considerations, form compatible blends.

Preferably the viscosity and surface energy of the core and/or shell polymer and the matrix polymer are close. Theoretically, a 1:1 ratio would be preferred. If the surface energy and/or the viscosity are too dissimilar, nanofibers may not be able to form. In one embodiment, the matrix polymer has a higher viscosity than the core polymer.

The core polymer, shell polymer, and matrix polymer may be selected from any thermoplastic polymers that meet the conditions stated above, are melt-processable, and are suitable for use in the end product. Suitable polymers for either the core, shell, and matrix polymers include, but are not limited to polyacetals, polyacrylics, polycarbonates, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polymethylpentene (and co-polymers thereof), polynorbornene (and co-polymers thereof), polyethylene terephthalates, polyvinylidene fluorides, polysiloxanes, or the like, or a combination comprising at least one of the foregoing thermoplastic polymers. In some embodiments, polyolefins include polyethylene, cyclic olefin copolymers (e.g. TOPAS®), poly(α-olefin)s. As used herein, poly(α-olefin) means a polymer made by polymerizing an alpha-olefin. An α-olefin is an alkene where the carbon-carbon double bond starts at the α-carbon atom. Exemplary poly(α-olefin)s include polypropylene, poly(I-butene) and polystyrene. Exemplary polyesters include condensation polymers of a C₂₋₁₂ dicarboxylic acid and a C₂₋₁₂ alkylenediol. Exemplary polyamides include condensation polymers of a C₂₋₁₂ dicarboxylic acid and a C₂₋₁₂ alkylenediamine. Additionally, the core, shell and/or matrix polymers may be copolymers and blends of polyolefins, styrene copolymers and terpolymers, ionomers, ethyl vinyl acetate, polyvinylbutyrate, polyvinyl chloride, metallocene polyolefins, poly(alpha olefins), ethylene-propylene-diene terpolymers, fluorocarbon elastomers, other fluorine-containing polymers, polyester polymers and copolymers, polyamide polymers and copolymers, polyurethanes, polycarbonates, polyketones, and polyureas, as well as polycaprolactam (Nylon 6).

In one embodiment, some preferred polymers are those that exhibit an alpha transition temperature (Tα) and include, for example: high density polyethylene, linear low density polyethylene, ethylene alpha-olefin copolymers, polypropylene, poly(vinylidene fluoride), poly(vinyl fluoride), poly(ethylene chlorotrifluoroethylene), polyoxymethylene, poly(ethylene oxide), ethylene-vinyl alcohol copolymer, and blends thereof. Blends of one or more compatible polymers may also be used in practice of the invention. Particularly preferred polymers are polyolefins such as polypropylene and polyethylene that are readily available at low cost and may provide highly desirable properties in the microfibrous articles used in the present invention, such properties including high modulus and high tensile strength.

Useful polyamide polymers include, but are not limited to, synthetic linear polyamides, e.g., nylon-6, nylon-6,6, nylon-11, or nylon-12. Polyurethane polymers which may be used include aliphatic, cycloaliphatic, aromatic, and polycyclic polyurethanes. Also useful are polyacrylates and polymethacrylates, which include, for example, polymers of acrylic acid, methyl acrylate, ethyl acrylate, acrylamide, methylacrylic acid, methyl methacrylate, n-butyl acrylate, and ethyl acrylate, to name a few. Other useful substantially extrudable hydrocarbon polymers include polyesters, polycarbonates, polyketones, and polyureas. Useful fluorine-containing polymers include crystalline or partially crystalline polymers such as copolymers of tetrafluoroethylene with one or more other monomers such as perfluoro(methyl vinyl)ether, hexafluoropropylene, perfluoro(propyl vinyl)ether; copolymers of tetrafluoroethylene with ethylenically unsaturated hydrocarbon monomers such as ethylene, or propylene.

Representative examples of polyolefins useful in this invention are polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene. Representative blends of polyolefins useful in this invention are blends containing polyethylene and polypropylene, low-density polyethylene and high-density polyethylene, and polyethylene and olefin copolymers containing the copolymerizable monomers, some of which are described above, e.g., ethylene and acrylic acid copolymers; ethyl and methyl acrylate copolymers; ethylene and ethyl acrylate copolymers; ethylene and vinyl acetate copolymers-, ethylene, acrylic acid, and ethyl acrylate copolymers, and ethylene, acrylic acid, and vinyl acetate copolymers.

The thermoplastic polymers may include blends of homo- and copolymers, as well as blends of two or more homo- or copolymers. Miscibility and compatibility of polymers are determined by both thermodynamic and kinetic considerations. A listing of suitable polymers may also be found in PCT published application WO2008/028134, which is incorporated in its entirety by reference.

The thermoplastic polymers may be used in the form of powders, pellets, granules, or any other melt-processable form. The particular thermoplastic polymer selected for use will depend upon the application or desired properties of the finished product. The thermoplastic polymer may be combined with conventional additives such as light stabilizers, fillers, staple fibers, anti-blocking agents and pigments. The three polymers are blended while both are in the molten state, meaning that the conditions are such (temperature, pressure) that the temperature is above the melting temperature (or softening temperature) of all of the polymers to ensure good mixing. This is typically done in an extruder. The polymers may be run through the extruder more than once to ensure good mixing to create discontinuous regions formed from the core and shell polymers in the matrix polymer.

In one embodiment, the ratio of nanofiber (including both the core polymer and the shell polymer) to matrix polymer is about 5% to about 90% by volume, preferably from 10% to about 70% vol, more preferably from 15% to about 60% vol, even more preferably from about 17% to about 50% vol. In another embodiment, the volume ratio is from about 100:1 to about 1:100, preferably, from about 40:1 to 1:40, more preferably from about 30:1 to about 1:30, even more preferably, from 20:1 to about 1:20; still even more preferably from 10:1 to 1:10; preferably from 3:2 to about 2:3. (4:1, 1:4) Preferably, the matrix polymer is the major phase comprising more than 50% by volume of the mixture.

Some preferred matrix polymer, core polymer, solvent combinations include, but are not limited to:

| Matrix polymer | Core polymer | Solvent (for matrix) |
|---|---|---|
| Polymethyl methacrylate | Polypropylene (PP) | Toluene |
| (PMMA) | | |
| Cyclic olefin Copolymer | PP | Toluene |
| Cyclic Olefin copolymer | Thermoplastic | Toluene |
| | Elastomer (TPE) | |
| Cyclic Olefin Copolymer | Polyethylene (PE) | Toluene |
| Cyclic Olefin Copolymer | Polymethylpentene | Toluene |
| Polystyrene (PS) | Linear Low density | Toluene |
| | polyethylene (LLDPE) | |
| Nylon 6 | PP | Formic Acid |
| Nylon 6 | PE | Formic Acid |
| PS | Polyethylene | Toluene |
| | terephthalate (PET) | |
| PET | PP | decomposition |
| | | through hydrolysis |
| TPU (Thermoplastic | PP | Dimethyl |
| Polyurethane) | | formamide (DMF) |
| TPU | PE | DMF |
| TPU | Nylon | DMF |
| poly(vinyl alcohol) (PVA) | PP | Water |
| Cyclic olefin | TPU | Toluene |
| PS | TPU | Toluene |
| Polycarbonate (PC) | Nylon | Toluene |
| PC | PP | Toluene |
| Polyvinyl chloride (PVC) | PP | Chloroform |
| Noryl (Polyphenyleneoxide | PP | Toluene |
| PPO and PS blend) | | |
| Noryl | Nylon 6 | Chloroform |
| Polyacrylonitrilebutadiene- | Nylon 6 | Hexane |
| styrene (ABS) | | |
| ABS | PP | Chloroform |
| PVC | Nylon | Benzene |
| Polybutyleneterephthalate | PE | trifluoroacetic acid |
| (PBT) | | |

In one embodiment, the matrix polymer is polystyrene and the core polymer could be linear low density polyethylene (LLDPE), high density polyethylene (HDPE), isotactic polypropylene (iPP), polyethylene terephthalate (PET), polytrimethylene terephthalate (PTT), polybutylene terephthalate (PBT), poly(butylene adipate terephthalate) (PBAT), poly(Ethylene terephthalate-co-isophthalate)-poly(ethylene glycol) (IPET-PEG), and a highly modified cationic ion-dyeable polyester (HCDP).

Maleated polypropylene (PP-G-MA)/PP shell/core nanofibers offer increased polarity and functional groups for further functionalization. Hyperbranched polymer (shell) nanofibers provides multifunctional sites. PVP-PPC (shell) and poly(propylene carbonate) PPC (core) can be used to make hollow nanofibers, Other combination include core/shell: nylon/thermoplastic polyurethane and PP/polyvinylidene fluoride.

In one embodiment, the matrix is a water vapor permeable material such as PEBAX resin, a block copolymer of nylon a polyether, by Arkema or a water vapor permeable thermoplastic polyurethane (TPU). The nanofibers in the layer reinforce the layer and also serve as a moisture barrier. When this layer is laminated on a fabric via extrusion coating or calendaring, a breathable water proof fabric composite is created without the matrix material (second polymer) having to be removed.

The core and shell polymers may be chosen with to have a different index of refraction or birefringence for desired optical properties. In another embodiment, the core polymer is soluble in a second solvent (which may be the same solvent or different solvent as the first solvent), such that the core of the core/shell nanofibers may be removed leaving bonded hollow nanofibers.

In another embodiment, a third component may be added. This third component may be a polymer, particle, blooming agent, small molecule or any other suitable component. In one embodiment, the third component is a third thermoplastic polymer that may be form additional nanofibers or additional matrix. The third component may be soluble or insoluble in the solvent that the matrix polymer is soluble in, depending on the desired end product. In one embodiment, the core and third polymers are insoluble in a solvent that the matrix polymer is soluble in. The amounts of polymers are selected such that the core/shell nanofibers are formed along with other nanofibers formed from the third polymer. The third polymer may form nanofibers which vary in composition or size (length and/or diameter) as compared to the core/shell nanofibers.

In another embodiment, the third component is a co-polymer. For example a polypropylene (PP), polystyrene (PS) and a polypropylene-graft-polystyrene (PP-g-PS) copolymer could be melt mixed at molten state in at a weight ratio of 76/19/5 using a twin screw extruder. The PP would be the core polymer, the PS would be the matrix polymer, and the PP-g-PS would be the shell polymer.

In another embodiment, the third component may be any suitable material the blooms or moves to the surface of the core polymer when subjected to heat and extensional forces. In some embodiments, the third component may be a polymer, co-polymer, a large molecule, or a small molecule. Typically, the third component has a smaller molecular weight than the bulk polymer. In one embodiment, the third component has one-tenth the molecular weight of the bulk polymer. In another embodiment, the third component has one-thousandth the molecular weight of the bulk polymer. In another embodiment, the third component has one-millionth the molecular weight of the bulk polymer. As a general rule, the greater the difference between the molecular weights of the bulk polymer and third component, the greater the amount of bloom (which results in more of the third component at the surface of the nanofiber). In one embodiment, the third component is a lubricant. The third component being a lubricant would help control the release properties of the nanofibers and non-woven. The third component being a lubricant also allows the nanofibers to more easily move across each other during consolidation giving better randomization. A lubricant could also alter the mechanical properties of the final non-woven structure.

In one embodiment, the core/shell nanofiber non-woven may contain any suitable particle, including nano-particles, micron-sized particles or larger. “Nano-particle” is defined in this application to be any particle with at least one dimension less than one micron. The particles may be, but are not limited to, spherical, cubic, cylindrical, platelet, and irregular. Preferably, the nano-particles used have at least one dimension less than 800 nm, more preferably less than 500 nm, more preferably, less than 200 nm, more preferably less than 100 nm. The particles may be organic or inorganic.

Examples of suitable organic particles include buckminsterfullerenes (fullerenes), dendrimers, organic polymeric nanospheres, aminoacids, and linear or branched or hyperbranched “star” polymers such as 4, 6, or 8 armed polyethylene oxide with a variety of end groups, polystyrene, superabsorbing polymers, silicones, crosslinked rubbers, phenolics, melamine formaldehyde, urea formaldehyde, chitosan or other biomolecules, and organic pigments (including metallized dyes).

Examples of suitable inorganic particles include, but are not limited to, calcium carbonate, calcium phosphate (e.g., hydroxy-apatite), talc, mica, clays, metal oxides, metal hydroxides, metal sulfates, metal phosphates, silica, zirconia, titania, ceria, alumina, iron oxide, vanadia, antimony oxide, tin oxide, alumina/silica, zirconium oxide, gold, silver, cadmium selenium, chalcogenides, zeolites, nanotubes, quantum dots, salts such as CaCO₃, magnetic particles, metal-organic frameworks, and any combinations thereof.

In one embodiment, the particles are further functionalized. Via further chemistry, the third surface of the particles may have added functionality (reactivity, catalytically functional, electrical or thermal conductivity, chemical selectivity, light absorption) or modified surface energy for certain applications.

In another embodiment, particles are organic-inorganic, coated, uncoated, or core-shell structure. In one embodiment, the particles are PEG (polyethylene glycol) coated silica, PEG coated iron oxide, PEG coated gold, PEG coated quantum dots, hyperbranched polymer coated nano-clays, or other polymer coated inorganic particles such as pigments. The particles, in one embodiment, may melt and re-cool in the process of forming the nanofiber non-woven. The particles may also be an inorganic core-inorganic shell, such as Au coated magnetic particles. The particles, in one embodiment, may melt and re-cool in the process of forming the nanofiber non-woven. In another embodiment, the particles are ZELEC®, made by Milliken and Co. which has a shell of antimony tin oxide over a core that may be hollow or solid, mica, silica or titania. A wax or other extractable coating (such as functionalized copolymers) may cover the particles to aid in their dispersion in the matrix polymer.

In another embodiment, the core/shell nanofiber non-woven contains at least one textile layer which may be any suitable textile layer. The textile layer may be on one or both sides of the core/shell nanofiber non-woven, or between some layers of the core/shell nanofiber non-woven. If more than one textile layer is used, they may each contain the same or different materials and constructions. In one embodiment, the textile layer is selected from the group consisting of a knit, woven, non-woven, and unidirectional layer. The textile layer provides turbulence of the molten mixture of the first and second polymer during extrusion and/or subsequent consolidation causing nanofiber movement, randomization, and bonding. The textile layer may be formed from any suitable fibers and/or yarns including natural and man-made. Woven textiles can include, but are not limited to, satin, twill, basket-weave, poplin, and crepe weave textiles. Jacquard woven textiles may be useful for creating more complex electrical patterns. Knit textiles can include, but are not limited to, circular knit, reverse plaited circular knit, double knit, single jersey knit, two-end fleece knit, three-end fleece knit, terry knit or double loop knit, warp knit, and warp knit with or without a micro denier face. The textile may be flat or may exhibit a pile. The textile layer may have any suitable coating upon one or both sides, just on the surfaces or through the bulk of the textile. The coating may impart, for example, soil release, soil repel/release, hydrophobicity, and hydrophilicity.

As used herein yarn shall mean a continuous strand of textile fibers, spun or twisted textile fibers, textile filaments, or material in a form suitable for knitting, weaving, or otherwise intertwining to form a textile. The term yarn includes, but is not limited to, yarns of monofilament fiber, multifilament fiber, staple fibers, or a combination thereof. The textile material may be any natural or man-made fibers including but not limited to man-made fibers such as polyethylene, polypropylene, polyesters (polyethylene terephthalate, polybutylene terephthalate, polytrimethylene terephthalate, polylactic acid, and the like, including copolymers thereof), nylons (including nylon 6 and nylon 6,6), regenerated cellulosics (such as rayon), elastomeric materials such as Lycra™, high-performance fibers such as the polyaramids, polyimides, PEI, PBO, PBI, PEEK, liquid-crystalline, thermosetting polymers such as melamine-formaldehyde (BASOFIL™) or phenol-formaldehyde (KYNOL™), basalt, glass, ceramic, cotton, coir, bast fibers, proteinaceous materials such as silk, wool, other animal hairs such as angora, alpaca, or vicuna, and blends thereof.

In another embodiment, the core/shell nanofiber non-woven further comprises a support layer which may be one at least one side of the core/shell nanofiber non-woven. The core/shell nanofiber non-woven and supporting layer may formed together, preferably through co-extrusion or attached together at a later processing step. If the supporting layer is co-extruded, then the supporting layer contains the supporting polymer which may be any suitable thermoplastic that is co-extrudable which the choice of core polymer and matrix polymer. The supporting polymer may be selected from the listing of possible thermoplastic polymers listed for the core polymer and the matrix polymer. In one embodiment, the supporting polymer is the same polymer as the matrix polymer or is soluble in the same solvent as the matrix polymer. This allows the matrix and the supporting layer (which is a sacrificial layer) to be removed at the same time leaving just the nanofibers in the nanofiber non-woven layer. In another embodiment, the supporting polymer is a different polymer than the matrix polymer and is not soluble in the same solvents as the matrix polymer. This produces a core/shell nanofiber non-woven on the supporting layer after removing the matrix polymer which is advantageous for applications that require a non-woven having increased dimensional stability and strength. The supporting layer decreases the edge effects of extruding or otherwise forming the core/shell nanofiber non-woven so that the size and density of the nanofibers is more even across the thickness (from the first side to the second side) of the core/shell nanofiber non-woven.

One process to form the core/shell nanofiber non-woven 10 begins with blending the core polymer, the shell polymer, and the matrix polymer in a molten state. The core polymer forms discontinuous regions in the matrix polymer with the shell polymer moving to the interface between the core polymer and the matrix polymer. The shell polymer at least partially surrounds the core polymer and preferably completely encapsulates the core polymer. These discontinuous regions may be nano-, micro-, or larger sized liquid drops dispersed in the matrix polymer. This blend may be cooled or used directly in the next processing step. The core and shell polymers are insoluble in the first solvent and the core polymer and shell polymer are not miscible.

Next, the polymer blend (heated if the polymer blend was cooled) is subjected to extensional flow and shear stress such that the core polymer and shell polymer form core/shell nanofibers. The core/shell nanofibers formed have an aspect ratio of at least 5:1 (length to diameter), more preferably, at least 10:1, at least 50:1, at least 100:1, and at least 1000:1. The shell of the core/shell nanofibers is typically less than 25 nm, more preferably less than 10 nm, more preferably less than 2 nm. In another embodiment, the shell of the nanofibers has a thickness of less than 10% of the diameter of the core/shell nanofiber, more preferably less than 5%, more preferably less than 1%. The core/shell nanofibers are generally aligned along an axis, referred to herein as the “nanofiber axis”.

At least a portion of the core polymer interpenetrates the shell of the nanofiber and at least a portion of the shell polymer interpenetrates the core of the nanofiber. This occurs as the core and shell polymers are heated and formed together. The polymer chains from the core polymers interpenetrate the shell and the polymer chains from the shell polymer interpenetrate the core and the core and shell polymers intermingle. This would not typically occur from a simple coating of already formed nanofibers with a coating polymer.

Preferably, at least 80% of the core/shell nanofibers are aligned within 20 degrees of this axis. After the extensional flow less than 30% by volume of the core/shell nanofibers are bonded to other core/shell nanofibers. This means that at least 70% of the core/shell nanofibers are not bonded (adhered or otherwise) to any other core/shell nanofiber. Should the matrix polymer by removed at this point, the result would be mostly separate, individual core/shell nanofibers. In another embodiment, less than 20%, less than 10%, or less than 5% of the core/shell nanofibers are bonded to other core/shell nanofibers.

In one embodiment, the mixing of the core, shell, and matrix polymers and the extension flow may be performed by the same extruder, mixing in the barrel of the extruder, then extruded through the die or orifice. The extensional flow and shear stress may be from, for example, extrusion through a slit die, a blown film extruder, a round die, injection molder, or a fiber extruder. These materials may then be subsequently drawn further in either the molten or softened state.

Next, the molten polymer blend is cooled to a temperature below the softening temperature of the core and shell polymers to preserve the core/shell nanofiber shape. “Softening temperature” is defined to be the temperature where the polymers start to flow. For crystalline polymers, the softening temperature is the melting temperature. For amorphous polymers, the softening temperature is the Vicat temperature. This cooled molten polymer blend forms the first intermediate.

Next, the first intermediate is formed into a pre-consolidation formation. Forming the first intermediate into a pre-consolidation formation involves arranging the first intermediate into a form ready for consolidation. The pre-consolidation formation may be, but is not limited to, a single film, a stack of multiple films, a fabric layer (woven, non-woven, knit, unidirectional), a stack of fabric layers, a layer of powder, a layer of polymer pellets, an injection molded article, or a mixture of any of the previously mentioned. The polymers in the pre-consolidation formation may be the same through the layers and materials or vary.

In a first embodiment, the pre-consolidation formation is in the form of a fabric layer. In this embodiment, the molten polymer blend is extruded into fibers which form the first intermediate. The fibers of the first intermediate are formed into a woven, non-woven, knit, or unidirectional layer. This fabric layer may be stacked with other first intermediate layers such as additional fabric layers or other films or powders.

In another embodiment, the pre-consolidation formation is in the form of a film layer. In this embodiment, the molten polymer blend is extruded into a film which forms the first intermediate. The film may be stacked with other films or other first intermediate layers. The film may be consolidated separately or layered with other films. In one embodiment, the films are stacked such that the core/shell nanofiber axes all align. In another embodiment, the films are cross-lapped such that the core/shell nanofiber axis of one film is perpendicular to the core/shell nanofiber axes of the adjacent films. If two or more films are used, they may each contain the same or different polymers. For example, a core/matrix PP/PS 80%/20% wt film may be stacked with a core/matrix PP/PS 75%/25% wt film. Additionally, a core/matrix PE/PS film may be stacked on a PP/PS film.

In another embodiment, the pre-consolidation formation is in the form of a structure of pellets, which may be a flat layer of pellets or a three-dimensional structure. In this embodiment, the molten polymer blend is extruded into a fiber, film, tube, elongated cylinder or any other shape and then is pelletized which forms the first intermediate. Pelletizing means that the larger cooled polymer blend is chopped into finer components. The most common pelletizing method is to extrude a pencil diameter fiber, then chop the cooled fiber into pea-sized pellets. The pellets may be covered or layered with any other first intermediate structures such as fabric layers or film layers.

In another embodiment, the pre-consolidation formation is in the form of a structure of a powder, which may shaped into be a flat layer of powder or a three-dimensional structure. In this embodiment, the molten polymer blend is extruded, cooled, and then ground into a powder which forms the first intermediate. The powder may be covered or layered with any other first intermediate structures such as fabric layers or film layers.

In another embodiment, the pre-consolidation formation is in the form of a structure of an injection molded article. The injection molded first intermediate may be covered or layered with any other first intermediate structures such as fabric layers or film layers.

Additionally, the pre-consolidation formation may be layered with other layers (not additional first intermediates) such as fabric layers or other films not having nanofibers or embedded into additional layers or matrices. One such example would be to embed first intermediate pellets into an additional polymer matrix. The pre-consolidation layer may also be oriented by stretching in at least one axis.

Consolidation is conducted at a temperature is above the T_{g} and the core, shell, and matrix polymers and within 50 degrees Celsius of the softening temperature of core polymer. More preferably, consolidation is conducted at 20 degrees Celsius of the softening temperature of the core polymer. The consolidation temperature upper limit is affected by the pressure of consolidation and the residence time of consolidation. For example, a higher consolidation temperature may be used if the pressure used is high and the residence time is short. If the consolidation is conducted at a too high a temperature, too high a pressure and/or too long a residence time, the fibers might melt into larger structures or revert back into discontinuous or continuous spheres.

Consolidating the pre-consolidation formation causes core/shell nanofiber movement, randomization, and at least 70% by volume of the core/shell nanofibers to fuse to other core/shell nanofibers. This forms the second intermediate. This movement, randomization, and bonding of the core/shell nanofibers may be accomplished two ways. The first being that the pre-consolidation formation contains multiple core/shell nanofiber axes. This may arise, for example, from stacking cross-lapped first intermediate layers or using a non-woven, or powder. When heat and pressure is applied during consolidation, the nanofibers move relative to one another and bond where they interact. Another method of randomizing and forming the bonds between the core/shell nanofibers is to use a consolidation surface that is not flat and uniform. For example, if a textured surface or fabric were used, even if the pressure was applied uniformly, the flow of the matrix and the nanofibers would be turbulent around the texture of the fabric yarns or the textured surface causing randomization and contact between the core/shell nanofibers. If one were to simply consolidate a single layer of film (having most of the nanofibers aligned along a single nanofiber axis) using a press that delivered pressure perpendicular to the plane of the film, the core/shell nanofibers would not substantially randomize or bond and once the matrix was removed, predominately individual (unattached) core/shell nanofibers would remain.

In pre-consolidation formations such as powders or pellets the core/shell nanofiber axes are randomized and therefore a straight lamination or press would produce off-axis pressure. The temperature, pressure, and time of consolidation would move the nanofibers between the first intermediate layers causing randomization and bonding of the core/shell nanofibers. Preferably, at least 75% of the core/shell nanofibers to bond to other core/shell nanofibers, more preferably at least 85%, more preferably at least 90%, more preferably at least 95%, more preferably at least 98% vol. Consolidation forms the second intermediate, also referred to as the nano-composite.

At applied pressure and temperature, the matrix polymer is allowed to flow and compress resulting in bringing “off-axis” core/shell nanofibers to meet at the cross over points and fuse together. Additional mixing flow of the core/shell polymer may also be used to enhance the mixing and randomization of the off-axis fibers. One conceivable means is using a textured non-melting substrate such as a fabric (e.g. a non-woven), textured film, or textured calendar roll in consolidation. Upon the application of pressure, the local topology of the textured surface caused the matrix polymer melt to undergo irregular fluctuations or mixing which causes the direction of the major axis of the core/shell nanofibers to alter in plane, resulting in off-axis consolidations. In a straight lamination or press process, due to the high melt viscosity and flow velocity, the flow of the matrix polymer melt is not a turbulent flow and cross planar flow is unlikely to happen. When the majority of the core/shell nanofibers are in parallel in the same plane, the core/shell nanofibers will still be isolated from each other, resulting in disintegration into individual core/shell nanofibers upon etching. The second intermediate (also referred to as the nano-composite) may be used, for example, in reinforcement structures, or a portion or the entire matrix polymer may be removed.

When the core/shell nanofibers bond to one other, the bond is almost always through the shell of the core/shell nanofibers such as shown in FIG. 2. Between the two bonded nanofibers are the shell layers of the two core/shell nanofibers. If a nanofiber non-woven was created with mono-layer nanofibers bonded to other mono-layer nanofibers then was coated, the resultant structure would have the coating on the fibers but not between the fibers where they were bonded together.

Next, optionally, at least a portion of the matrix polymer from the nano-composite creating the core/shell nanofiber non-woven 10. A small percentage (less than 30% vol) may be removed, most, or all of the matrix polymer may be removed. If just a portion of the matrix polymer is removed, it may be removed from the outer surface of the intermediate leaving the nano-composite having a nanofiber non-woven surrounding the center of the article which would remain a nano-composite. The removal may be across one or more surfaces of the second intermediate or may be done pattern-wise on the second intermediate. Additionally, the matrix polymer may be removed such that there is a concentration gradient of the matrix polymer in the final product with the concentration of the matrix polymer the lowest at the surfaces of the final product and the highest in the center. The concentration gradient may also be one sided, with a concentration of the second polymer higher at one side.

If essentially the entire or the entire matrix polymer is removed from the second intermediate, what remains is a core/shell nanofiber non-as shown in FIG. 1, where at least 70% vol of the core/shell nanofibers are bonded to other core/shell nanofibers. While the resultant structure is described as a core/shell nanofiber non-woven, the resultant structure may consist of a non-woven formed from bonded nanofibers and resemble a film more than a non-woven. The bonding between the core/shell nanofibers provides physical integrity for handling of the etched films/non-woven in the etching process which makes the use of a supporting layer optional. Smearing and/or tearing of the nanofibers upon touching is commonly seen in the poorly consolidated second intermediates. The matrix polymer may be removed using a suitable first solvent or decomposition method described above.

The benefit of the process of consolidating the pre-consolidation layer is the ability to form the bonds between the core/shell nanofibers without losing the nanofiber structure. If one were to try to bond the core/shell nanofibers in a nanofiber non-woven, when heat is applied, the core/shell nanofibers would all melt together and the core/shell nanofiber structure would be lost. This would occur when the heat is uniform, such as a lamination or nip roller, or is specific such as spot welding or ultrasonics.

In one embodiment, the core/shell nanofiber non-woven 10 may contain additional microfibers and/or engineering fibers. Engineering fibers are characterized by their high tensile modulus and/or tensile strength. Engineering fibers include, but are not limited to, E-glass, S-glass, boron, ceramic, carbon, graphite, aramid, poly(benzoxazole), ultra high molecular weight polyethylene (UHMWPE), and liquid crystalline thermotropic fibers. The use of these additional fibers in the composites and non-wovens/films may impart properties that may not be realized with a single fiber type. For example, the high stiffness imparted by an engineering fiber may be combined with the low density and toughness imparted by the nanofibers. The extremely large amount of interfacial area of the nanofibers may be effectively utilized as a means to absorb and dissipate energy, such as that arising from impact. In one embodiment a nanofibers mat comprised of hydrophobic nanofibers is placed at each of the outermost major surfaces of a mat structure, thereby forming a moisture barrier for the inner layers. This is especially advantageous when the inner layers are comprised of relatively hydrophilic fibers such as glass.

In one embodiment, the bonded core/shell nanofibers may improve the properties of existing polymer composites and films by providing nanofiber-reinforced polymer composites and films, and corresponding fabrication processes, that have a reduced coefficient of thermal expansion, increased elastic modulus, improved dimensional stability, and reduced variability of properties due to either process variations or thermal history. Additionally, the increased stiffness of the material due to the nanofibers may be able to meet given stiffness or strength requirements.

The bonded core/shell nanofibers of the core/shell nanofiber non-woven may be used in many known applications employing nanofibers including, but not limited to, filter applications, catalysis, adsorbtion and separation applications, computer hard drive applications, biosensor applications and pharmaceutical applications. In one application, a nanofibrillar structure for cell culture and tissue engineering may be fabricated using the nanofibers of the present invention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A core/shell nanofiber non-woven comprising a plurality of core/shell nanofibers, wherein at least 70% of the nanofibers are bonded to other nanofibers, wherein the core of the nanofiber comprises a core polymer and the shell of the nanofiber comprises a shell polymer, wherein at least a portion of the core polymer interpenetrates the shell of the nanofiber and at least a portion of the shell polymer interpenetrates the core of the nanofiber.

2. The core/shell nanofiber non-woven of claim 1, wherein the core/shell nanofiber non-woven further comprises a matrix polymer at least partially encapsulating the nanofibers.

3. The core/shell nanofiber non-woven of claim 1, wherein the shell polymer is located between the bonds of the nanofibers.

4. The core/shell nanofiber non-woven of claim 1, wherein the shell/core nanofibers are bonded to other core/shell nanofibers through the shell polymer.

5. The core/shell nanofiber non-woven of claim 1, wherein the core/shell nanofiber non-woven further comprises additional fibers having a different size or chemical composition than the nano-fibers.

6. The core/shell nanofiber non-woven of claim 1, wherein at least 85% by volume of the nanofibers are fused to other nanofibers.

7. The core/shell nanofiber non-woven of claim 1, wherein the shell portion of the core/shell nanofiber has a thickness no greater than 10% of the diameter of the nanofiber.

8. The process of forming a core/shell nanofiber non-woven comprising, in order:
a) mixing a core thermoplastic polymer, a shell thermoplastic polymer and a matrix thermoplastic polymer in a molten state forming a molten polymer blend, wherein the matrix polymer is soluble in a first solvent, wherein the core and shell polymers are insoluble in the first solvent, wherein the core polymer is not miscible with the shell polymer, wherein the core polymer forms discontinuous regions in the matrix polymer, wherein the shell polymer forms a shell around the discontinuous regions between the core polymer and the matrix polymer and optionally cooling the polymer blend to a temperature below the softening temperature of the core and shell polymers;
b) subjecting the polymer blend to extensional flow, shear stress, and heat such that the core and shell polymers forms core/shell nanofibers having an aspect ratio of at least 5:1, and wherein less than about 30% by volume of the nanofibers are bonded to other nanofibers, wherein the nanofibers are generally aligned along an axis, wherein at least a portion of the core polymer interpenetrates the shell of the nanofiber and at least a portion of the shell polymer interpenetrates the core of the nanofiber;
c) cooling the polymer blend with nanofibers to a temperature below the softening temperature of the core and shell polymers to preserve the nanofiber shape forming a first intermediate;
d) forming the first intermediate into a pre-consolidation formation;
e) consolidating the pre-consolidation formation at a consolidation temperature forming a second intermediate, wherein the consolidation temperature is above the T_{g} and of core, shell, and matrix polymers, wherein consolidating the pre-consolidation formation causes core/shell nanofiber movement, randomization, and at least 70% by volume of the core/shell nanofibers to fuse to other core/shell nanofibers; and,
f) applying the first solvent to the second intermediate removing at least a portion of the matrix polymer.

9. The process of claim 8, wherein subjecting the molten polymer blend to extensional flow and shear stress comprises extruding the molten polymer blend into fibers and wherein forming the pre-consolidated formation comprises forming the fibers into a non-woven layer and stacking at least one non-woven layer.

10. The process of claim 8, wherein subjecting the molten polymer blend to extensional flow and shear stress comprises extruding the molten polymer blend into fibers and wherein forming the pre-consolidated formation comprises forming the fibers into a knit or woven layer and stacking at least one knit or woven layer and

11. The process of claim 8, wherein at least 85% by volume of the nanofibers are fused to other nanofibers in the second intermediate.

12. The process of claim 8, wherein less than about 10% by volume of the nanofibers are fused to other nanofibers in the first intermediate.

13. The process of claim 8, wherein the shell polymer is located between the bonds of the nanofibers.

14. The process of claim 8, wherein the shell/core nanofibers are bonded to other core/shell nanofibers through the shell polymer.

15. The core/shell nanofiber non-woven formed by the process comprising:
a) mixing a core thermoplastic polymer, a shell thermoplastic polymer and a matrix thermoplastic polymer in a molten state forming a molten polymer blend, wherein the matrix polymer is soluble in a first solvent, wherein the core and shell polymers are insoluble in the first solvent, wherein the core polymer is not miscible with the shell polymer, wherein the core polymer forms discontinuous regions in the matrix polymer, wherein the shell polymer forms a shell around the discontinuous regions between the core polymer and the matrix polymer and optionally cooling the polymer blend to a temperature below the softening temperature of the core and shell polymers;
b) subjecting the polymer blend to extensional flow, shear stress, and heat such that the core and shell polymers forms core/shell nanofibers having an aspect ratio of at least 5:1, and wherein less than about 30% by volume of the nanofibers are bonded to other nanofibers, wherein the nanofibers are generally aligned along an axis, wherein at least a portion of the core polymer interpenetrates the shell of the nanofiber and at least a portion of the shell polymer interpenetrates the core of the nanofiber;
c) cooling the polymer blend with nanofibers to a temperature below the softening temperature of the core and shell polymers to preserve the nanofiber shape forming a first intermediate;
d) forming the first intermediate into a pre-consolidation formation;
e) consolidating the pre-consolidation formation at a consolidation temperature forming a second intermediate, wherein the consolidation temperature is above the T_{g} and of core, shell, and matrix polymers, wherein consolidating the pre-consolidation formation causes core/shell nanofiber movement, randomization, and at least 70% by volume of the core/shell nanofibers to fuse to other core/shell nanofibers; and,
f) applying the first solvent to the second intermediate removing at least a portion of the matrix polymer.

16. The core/shell nanofiber non-woven of claim 15, wherein the core/shell nanofiber non-woven further comprises a matrix polymer at least partially encapsulating the nanofibers.

17. The core/shell nanofiber non-woven of claim 15, wherein the shell polymer is located between the bonds of the nanofibers.

18. The core/shell nanofiber non-woven of claim 15, wherein the shell/core nanofibers are bonded to other core/shell nanofibers through the shell polymer.

19. The core/shell nanofiber non-woven of claim 15, wherein the core/shell nanofiber non-woven further comprises additional fibers having a different size or chemical composition than the nano-fibers.

20. The core/shell nanofiber non-woven of claim 15, wherein at least 85% by volume of the nanofibers are fused to other nanofibers.
